(19) United States
(12) Patent Application Publication
(10) Pub. No.: US 2017/0330136 A1
(43) Pub. Date: Nov. 16, 2017

(54) DISPENSER SUPPLY MANAGEMENT

(71) Applicant: ProStat First Aid, LLC, Valencia, CA (US)

(72) Inventor: Joseph Bratter, Valencia, CA (US)

(21) Appl. No.: 15/155,991

(22) Filed: May 16, 2016

(51) Int. Cl. G06Q 10/08; G06K 19/07; G06K 7/10

(52) U.S. Cl. CPC G06Q 10/087; G06K 7/10861; G06K 19/0723

(57) ABSTRACT

Techniques related to dispenser supply management are disclosed. A dispenser holds sets of different dispensable items. In response to selection of an individual item from one of the sets, means in the dispenser controllably dispenses the individual item. A computer system periodically receives one or more data transmissions indicating that a particular packaged item is stored in the dispenser at or near a time of receiving the one or more data transmissions. Based on a cessation of the one or more data transmissions, the computer system determines that the particular packaged item is missing from the sets of different dispensable items in the dispenser. In response to determining that the particular packaged item is missing from the dispenser, the computer system automatically generates and transmits, toward a recipient computer system via a computer network, a digital electronic message that includes a request to resupply the dispenser with packaged items.

### FIELD OF THE DISCLOSURE

The present disclosure generally relates to automated inventory control. More specifically, the example embodiment(s) of the present disclosure relate to supply management techniques applicable to dispensers of items such as consumable goods.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A dispenser can automatically dispense items in an organized manner. However, maintaining a steady supply of items in the dispenser is heavily dependent on human interaction. For example, restocking typically involves at least (1) manually determining that a supply of items is in a depleted state; (2) reporting the depleted state to someone who can obtain a new supply; and (3) manually ascertaining information necessary to obtain the new supply. As a result, if anyone neglects to perform his/her role in the restocking process, a particular item may be unavailable when needed. In one example context involving industrial first aid kits, the absence of a particular item can mean that an enterprise is unable to render first aid to an individual.

### SUMMARY

The appended claims may serve as a summary of the disclosure.

### BRIEF DESCRIPTION OF THE DRAWINGS

In the drawings:

FIG. 1 depicts an example supply management system comprising a computer system and a dispenser.

FIG. 2 depicts a detailed view of example data transmissions between the computer system and the dispenser.

FIG. 3 depicts an example resupply request that is transmitted toward a recipient computer system.

FIG. 4 depicts an example vendor-to-item mapping.

FIG. 5 depicts an example computer architecture comprising the supply management system and the recipient computer system.

FIG. 6 is a flow diagram that depicts an approach for dispenser supply management.

FIG. 7 depicts an example computer system upon which an embodiment may be implemented.

While each of the drawing figures illustrates a particular embodiment for purposes of illustrating a clear example, other embodiments may omit, add to, reorder, and/or modify any of the elements shown in the drawing figures. For purposes of illustrating clear examples, one or more figures may be described with reference to one or more other figures, but using the particular arrangement illustrated in the one or more other figures is not required in other embodiments.

### DETAILED DESCRIPTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure.

Embodiments are described herein according to the following outline:
1.0 General Overview
2.0 Supply Monitoring
   2.1 Supply Management System
   2.2 Data Transmissions
   2.3 Unique Identifiers
3.0 Resupply Requests
   3.1 Nth Item Identifier
   3.2 Vendor-to-Item Mapping
4.0 Example Network Topology for Dispenser Supply Management
   4.1 Dispenser
   4.2 Computer System
      4.2.1 Data Processing Logic
      4.2.2 Storage
      4.2.3 Item Detection Logic
      4.2.4 Request Generation Logic
   4.3 Recipient Computer System
5.0 Process Overview
   5.1 Receiving an Indication that a Packaged Item is Stored in a Dispenser
   5.2 Determining that the Packaged Item is Missing from the Dispenser
   5.3 Generating a Resupply Request
6.0 Implementation Mechanisms—Hardware Overview
7.0 Extensions and Alternatives

1.0 General Overview

A supply management system includes a computer system and a dispenser. The computer system monitors supply levels in the dispenser and automatically requests a new supply of items when a present supply of items is low or depleted. The dispenser may be configured to hold multiple sets of different dispensable items, such as a set of adhesive bandages and a set of aspirin tablets. Each dispensable item may be a packaged item. For example, each adhesive bandage may be individually sealed in a paper wrapper.

The computer system monitors supply levels in the dispenser based on transmitters (for example, radio-frequency identification tags) that are used for item detection. The transmitters are affixed to some items. For example, each set of dispensable items may include one item that has an attached transmitter. Each transmitter periodically provides the computer system with data transmissions that identify a particular item to which the transmitter is attached. The data transmissions indicate that the particular item is stored in the dispenser. In terms of a set of dispensable items that includes the particular item, detection of the particular item indicates that a supply of items in the set continues to be available in the dispenser. As a corollary to this principle, a cessation of the data transmissions indicates that the particular item is missing from the dispenser and that the supply of items in the set is either nearly depleted or completely depleted.

When the computer system determines that the particular item is missing, the computer system automatically generates a network message that includes a request to resupply the dispenser with another set of dispensable items. The computer system transmits the network message toward a recipient computer system that is associated with a vendor, a manufacturer, an inventory manager, and/or any other entity who can resupply the dispenser.

2.0 Supply Monitoring

In some example embodiments, a supply management system includes features for automatically monitoring supply levels in a dispenser. This may involve a computer system that determines supply levels in the dispenser based on periodically checking for representative items in the dispenser. Thus, a supply management system may include both a dispenser and a computer system for monitoring supplies in the dispenser.

2.1 Supply Management System

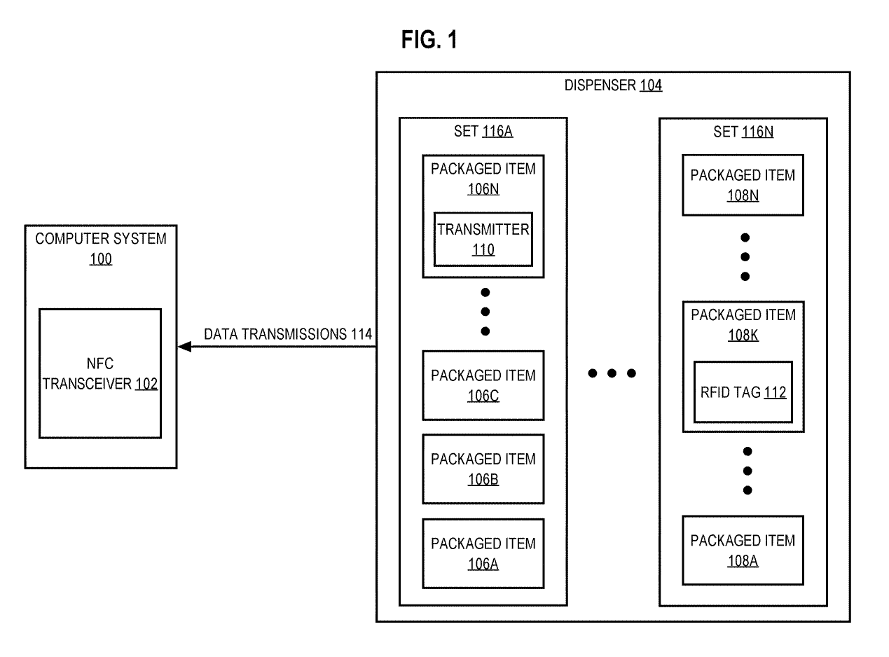

FIG. 1 depicts an example supply management system comprising a computer system and a dispenser. Referring to FIG. 1, computer system 100 includes near field communications (NFC) transceiver 102 and receives radio-frequency data transmissions 114 from dispenser 104. Dispenser 104 holds any number of sets 116A-N of dispensable items; the label “N” in “116N,” and in any other reference numeral herein, connotes that any number of elements, items or sets of items may be present or used in embodiments, as in “1 to n items”. Set 116A includes packaged items 106A-N, and set 116N includes packaged items 108A-N. Packaged item 106N has transmitter 110 affixed to it, and packaged item 108K has radio-frequency identification (RFID) tag 112 affixed to it.

Computer system 100 may include one or more physical computers, virtual computers, and/or computing devices. For example, computer system 100 may include one or more desktop computers, workstation computers, laptop computers, mobile devices, storage devices, virtual machine instances or virtual machine computing elements (for example, virtual processors, storage, and memory), and/or any special-purpose computing devices. In some example embodiments, computer system 100 may include auxiliary devices, such as a transceiver, a camera, and/or a barcode scanner.

In the example of FIG. 1, computer system 100 is depicted as if separate and remote from dispenser 104. For example, computer system 100 may include a smartphone that is periodically placed in proximity to dispenser 104. In some example embodiments, however, computer system 100 may be integrated with and/or affixed to dispenser 104. For example, computer system 100 may include computing elements (for example, processor, memory, storage) that are attached to or built into dispenser 104.

Dispenser 104 may be any apparatus, mechanism, and/or device that holds and controllably dispenses individual items. For example, dispenser 104 may be a wall-mounted first aid kit, a spring-loaded shelf pusher, and/or a vending machine with an auger or turnstile. The individual items may be packaged items (for example, cans of soda) or unpackaged items (for example, plastic cups). In the example of FIG. 1, dispenser 104 holds and controllably dispenses packaged items 106A-N, 108A-N.

Dispenser 104 includes means (not shown) for controllably dispensing an individual item. The means may include an aperture through which the individual item is dispensed. Additionally or alternatively, the means may include an apparatus, mechanism, or device (for example, a chute, a spring, a motor) that converts energy in one form (for example, potential energy) into another form (for example, kinetic energy). In some example embodiments, the energy may be converted in response to a trigger, such as selection of the individual item by a consumer. Additionally or alternatively, the means may include a vertical, horizontal, and/or diagonal (for example, inclined) guide that directs movement of the individual items within dispenser 104, thereby causing the individual items to be dispensed in a sequential order. In some example embodiments, the guide may also serve as a divider that organizes the individual items into multiple sets 116A-N of different dispensable items.

For example, dispenser 104 may be a wall-mounted first aid kit that harnesses gravitational energy to dispense individually packaged medical paraphernalia, such as individually wrapped pain relievers or adhesive bandages. Vertical guides may serve as chutes that direct motion in a vertical direction. The vertical guides may also serve as dividers that separate different sets of dispensable items. For example, a vertical guide may separate a continuous roll of adhesive bandages from a series of individual packets of aspirin. Horizontal dividers may also separate different sets of dispensable items into an upper and a lower region of dispenser 104. Dispenser 104 may have a front panel that is made of a transparent material, such as PLEXIGLASS. The front panel may have slots through which individual items are dispensed. Each slot may correspond to a different set of dispensable items. Thus, selecting a particular slot may be equivalent to selecting a dispensable item. A slot may also be equipped with a serrated edge or any other apparatus, mechanism, or device that separates an individual packaged item from a set of contiguous packaged items.

Referring to FIG. 1, dispenser 104 is configured to hold a plurality of sets 116A-N of different dispensable items. In some example embodiments, a set may be contained in an enclosure, such as a box or a carton, and the enclosure may be stored in dispenser 104. A repositionable adhesive, a hook-and-loop fastener, a metal or plastic clip, and/or any other mechanical retainer may be used to affix the enclosure to dispenser 104.

In the example of FIG. 1, each set of sets 116A-N includes a plurality of packaged items 106A-N, 108A-N. Each item in a particular set is nearly identical with respect to other items in the particular set. For example, each adhesive bandage in a roll is nearly identical to other adhesive bandages in the roll. Each packaged item is typically enclosed in a disposable packaging material, such as paper, plastic, aluminum, or any other inexpensive material.

2.2 Data Transmissions

At least one individual item (for example, packaged item 106N, packaged item 108K) in each set has a transmitter 110 affixed to it. The transmitter 110 may be any apparatus, mechanism, or device that is capable of sending data encoded in a signal. Typically, the transmitter 110 is affixed to packaging material or any other part of an item that is incidental to use of the item. The transmitter 110 is also typically disposable and inexpensive. An example of such a transmitter 110 is an RFID tag 112, which costs about $0.10 each. The transmitter 110 may be passive, battery-assisted passive, or active. However, passive transmitters are typically cheaper than battery-assisted passive or active transmitters.

Computer system 100 includes a signal receiver, such as a transceiver, an RFID tag reader, and/or any other apparatus, mechanism, and/or device that is capable of at least receiving a signal from a transmitter 110. The signal may be a data transmission that is encoded using any of a number of wireless communication protocols, such as near field communication (NFC), Bluetooth, etc. For example, computer system 100 may include NFC transceiver 102 and a smartphone that has an RFID reader app. The RFID reader app causes NFC transceiver 102 to interrogate RFID tag 112. NFC transceiver 102 interrogates RFID tag 112 based on sending a signal to RFID tag 112 and receiving, from RFID tag 112, a response to the signal.

Computer system 100 periodically (for example, at regular and/or irregular intervals) receives one or more data transmissions from the transmitter 110. In some example embodiments, a computer system 100 may be a component of a dispenser 104 containing transmitters that are interrogated at predetermined intervals, such as every hour. In some example embodiments, computer system 100 may be brought into proximity of dispenser 104 at irregular intervals, such as whenever a user of computer system 100 walks near dispenser 104, so that NFC transceiver 102 can interrogate transmitter 110 and/or RFID tag 112.

2.3 Unique Identifiers

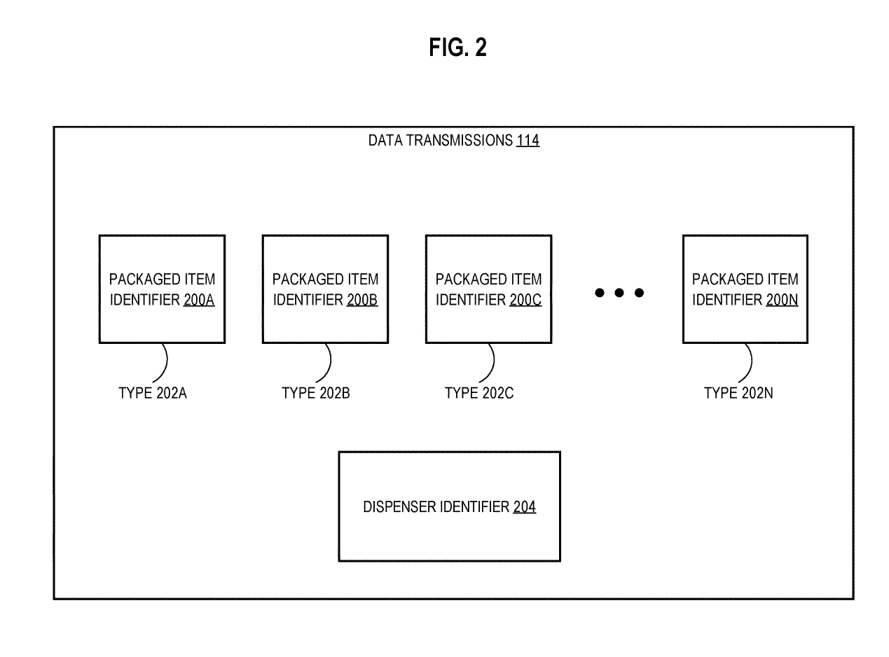

Computer system 100 determines whether an individual item (for example, packaged item 106N, packaged item 108K) is stored in or missing from dispenser 104 based on data included in data transmissions 114. FIG. 2 depicts a detailed view of example data transmissions. Referring to FIG. 2, data transmissions 114 include packaged item identifiers 200A-N and dispenser identifier 204. Packaged item identifiers 200A-N correspond to types 202A-N.

Computer system 100 receives each data transmission of data transmissions 114 from a different transmitter. Furthermore, computer system 100 periodically receives one or more data transmissions from each transmitter. The one or more data transmissions indicate that a particular item is stored in dispenser 104 at or near a time that computer system 100 receives the one or more data transmissions. For example, in FIG. 1, transmitter 110 corresponds to packaged item 106N of set 116A. Thus, computer system 100 periodically receives, from transmitter 110, one or more data transmissions indicating that packaged item 106N is stored in dispenser 104 at or near a time of receiving the one or more data transmissions. This is accomplished by an item identifier that includes an identification (for example, packaged item identifier 200A) of packaged item 106N. The item identifier is included in the one or more data transmissions from transmitter 110 to computer system 100. For example, a transmitter 110 may be manually (for example, by typing) or automatically (for example, by scanning a barcode) configured to transmit the item identifier as encoded data.

In some example embodiments, an item identifier uniquely identifies a particular item set. For example, each packaged item identifier of packaged item identifiers 200A-N may uniquely identify a particular set (for example, set 116A, set 116N) of dispensable items. In the example of FIG. 2, each packaged item identifier of packaged item identifiers 200A-N corresponds to a particular type of types 202A-N. Each type of types 202A-N may refer to one or more item characteristics (for example, manufacturer, quantity, size, color) that collectively distinguish sets (for example, sets 116A-N) of different dispensable items. For example, packaged item identifier 200A may include the following data: BAND-AID BANDAGES, ROLL OF 100, 1″ WIDTH, BEIGE COLOR; and packaged item identifier 200B may include the following data: CURAD BANDAGES, ROLL OF 100, 1″ WIDTH, BEIGE COLOR. Thus, packaged item identifiers 200A and 200B correspond to similar but different types. If packaged item identifier 200B had included BAND-AID BANDAGES instead of CURAD BANDAGES, packaged item identifiers 200A and 200B would have corresponded to a same type.

In some example embodiments, an item identifier uniquely identifies a particular item. For example, each packaged item identifier of packaged item identifiers 200A-N may uniquely identify a particular packaged item (for example, packaged item 106N, packaged item 108K). Computer system 100 may correlate the particular item to a particular item set based on a stored mapping between items and item sets.

As long as computer system 100 continues to receive a data transmission from a particular transmitter, computer system 100 can determine that a particular item (for example, packaged item 106N, packaged item 108K) corresponding to the particular transmitter remains stored in dispenser 104. As a corollary to this principle, computer system 100 can determine that a particular item is missing from dispenser 104 when computer system 100 fails to receive any further data transmissions from the particular transmitter. In other words, computer system 100 can determine that one or more individual items are missing from dispenser 104 based on a cessation of one or more data transmissions associated with the one or more individual items. For example, computer system 100 may store an initial set of packaged item identifiers received in an initial set of data transmissions. Subsequent packaged item identifiers received in subsequent data transmissions may then be compared to the initial set to determine whether the subsequent data transmissions failed to include any packaged item identifiers from the initial set. Thus, missing identifiers indicate missing items.

In some example embodiments, each data transmission of data transmissions 114 may also include an identification of dispenser 104 (for example, dispenser identifier 204) and/or a location of dispenser 104. For example, data transmissions 114 may include dispenser identifier 204 “KIT PSFA-102344” and location identifier “MEGACORPSTORE-0203”. In some example embodiments, computer system 100 may correlate dispenser identifier 204 to a location identifier and/or an address based on one or more stored mappings. A transmitter 110 may be manually or automatically configured to transmit encoded data that includes a dispenser identifier 204 and/or a location identifier. For example, a computer system 100 that is a component of a dispenser 104 may automatically configure each transmitter to transmit a dispenser identifier 204 and/or a location identifier of the dispenser 104.

In some example embodiments, a database may store one or more mappings between any of the identifiers mentioned above and information that is used to automatically generate a resupply request. For example, a location-identifier-to-address mapping may correlate “MEGACORPSTORE-0203” to “123 Main Street, Sunnyside, Calif. 91234”. The one or more mappings may be especially useful when an identifier is encoded in a format that is machine-friendly as opposed to human-friendly. For example, computer system 100 may use the one or more mappings to translate an item identifier that is scanned from a barcode into one or more item descriptions that can be entered into an order form.

3.0 Resupply Requests

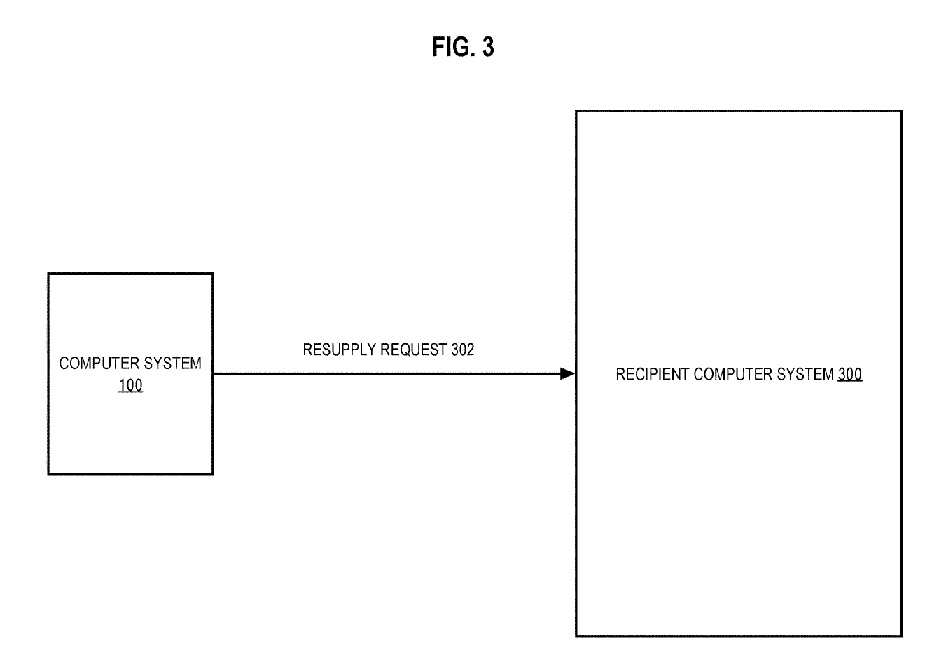

FIG. 3 depicts an example resupply request that is transmitted toward a recipient computer system. Referring to FIG. 3, computer system 100 transmits resupply request 302 toward recipient computer system 300.

Computer system 100 and recipient computer system 300 may be connected via a computer network, such as the Internet, a local area network (LAN), etc. For example, computer system 100 may be wirelessly connected to a gateway router that is ultimately connected, via a wired network connection, to recipient computer system 300. Recipient computer system 300 may be associated with a vendor, a manufacturer, an inventory manager, and/or any other entity who is capable of supplying dispenser 104 with dispensable items. For example, recipient computer system 300 may be a server computer that hosts an order form for dispensable items.

In response to detecting a missing item, computer system 100 automatically generates a digital electronic message that includes a request (for example, resupply request 302) to resupply dispenser 104 with a plurality of individual items. Typically, the plurality of individual items is of a same type as (for example, shares all item characteristics of) the missing item. Resupply request 302 includes information related to the missing item, such as a manufacturer, quantity, size, and/or color of the missing item; a dispenser identifier 204; a location identifier; and/or any other data received in a data transmission or retrieved from a mapping. The digital electronic message may store resupply request 302 in a format that enables transmission of resupply request 302 to recipient computer system 300 (for example, in an e-mail) and/or processing of resupply request 302 at recipient computer system 300 (for example, in a Hypertext Transfer Protocol post to a website).

In some example embodiments, the digital electronic message may include resupply request 302 as an automatically completed order form. For example, an app installed on computer system 100 may cause displaying of an order system interface, such as a shopping cart interface, including fields that are automatically populated with information received in a data transmission and/or retrieved from a mapping. The order system interface may provide options to cancel, modify, and/or confirm the automatically completed order form. When computer system 100 receives user confirmation as input at the order system interface, computer system 100 may transmit the digital electronic message toward recipient computer system 300.

In some example embodiments, the digital electronic message may cause recipient computer system 300 to automatically complete an order form. For example, the digital electronic message may be a HTTP post that computer system 100 automatically generates and transmits toward recipient computer system 300, which hosts a website that includes an order form. The HTTP post may include resupply request 302 as a Uniform Resource Locator (URL) that specifies the missing item. Recipient computer system 300 may automatically populate corresponding fields of the order form with information specified in the URL. The website may provide options to cancel, modify, and/or confirm the order form. Recipient computer system 300 may process the order form when recipient computer system 300 receives user confirmation as input at the website.

In some example embodiments, the digital electronic message may be unrelated to automatically completing an order form. For example, the digital electronic message may be an alert that computer system 100 automatically generates and transmits toward recipient computer system 300, which is associated with an inventory manager. In response to receiving the alert, which includes resupply request 302, the inventory manager may resupply dispenser 104.

3.1 Nth Item Identifier

A missing item may indicate that an item set to which the missing item belongs is either completely depleted or nearly depleted, depending on which item in the item set has an attached transmitter. For example, if a missing item is a final item in an item set, the missing item indicates that the item set is completely depleted. However, if a missing item is an nth item from an end of an item set where n>1, the missing item indicates that the item set is nearly depleted (for example, that a particular packaged item is missing but that one or more other packaged items of a same type are in dispenser 104). In either case, computer system 100 automatically generates a digital electronic message that includes a resupply request 302. However, an advantage to generating a digital electronic message when an item set is nearly depleted, as opposed to completely depleted, is that a time allowance is provided for resupplying dispenser 104. For example, the time allowance may account for a time period involved in shipping a new supply of items. Thus, nth item identifiers (for example, a transmitter 110 that is affixed to an nth item, instead of a final item, in an item set) are especially advantageous when the digital electronic message is related to automatically completing an order form. In particular, nth item identifiers may be used to avoid maintaining backup supplies that tie up resources (for example, capital, space) and that are vulnerable to theft or disorganization.

In some example embodiments, computer system 100 may automatically determine and recommend a value of n for a particular set. Computer system 100 may collect and maintain historical data related to the particular set. For example, the historical data may include a time period that elapses between a first time and a last time that a particular transmitter is detected. Typically, data encoded in each data transmission from the particular transmitter remains unchanged. Thus, computer system 100 may measure the time period based on comparing the data encoded in a pair of data transmissions and determining whether the data is identical in the pair of data transmissions. Based on the time period and a known quantity of items in the particular set (for example, based on information included in a data transmission or user input), computer system 100 may calculate a dispensing frequency for the particular set. Additionally or alternatively, computer system 100 may calculate an average dispensing frequency based on multiple dispensing frequencies. Based on the dispensing frequency and/or the average dispensing frequency, computer system 100 may estimate the value of n. Computer system 100 may adjust the value of n based on machine learning or any other heuristic algorithm.

For example, computer system 100 may determine that a set of 100 bandages took 20 days to become depleted. Thus, computer system 100 may calculate a dispensing frequency of 5 bandages per day. Since computer system 100 can access data indicating that resupply requests historically specified a 2-day shipping option, computer system 100 may recommend a value of 10 for n. In other words, computer system 100 may display a recommendation to affix a transmitter 110 to the 90^{th} bandage in the set.

3.2 Vendor-to-Item Mapping

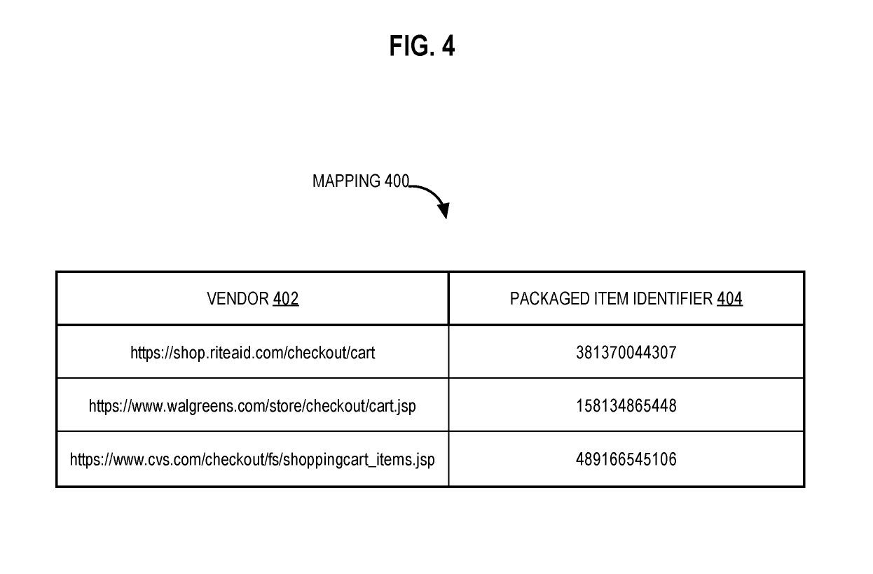

In some example embodiments, a dispenser 104 may store items supplied by different sources (for example, vendors, manufacturers). Thus, computer system 100 may automatically generate multiple messages, each message being transmitted toward a different recipient computer system. However, computer system 100 may determine a corresponding recipient computer system for a missing item based on a mapping, such as a vendor-to-item mapping. FIG. 4 depicts an example vendor-to-item mapping. Referring to FIG. 4, mapping 400 maps vendor 402 to packaged item identifier 404.

A database may store mapping 400, which maps vendor information to item information. Based on mapping 400, computer system 100 may determine a vendor 402 of a particular item. In the example of FIG. 4, vendor information corresponds to a website of a vendor 402, and item information corresponds to an item barcode that was encoded in a data transmission.

For example, computer system 100 receives a data transmission that includes data corresponding to a particular packaged item (for example, the packaged item identifier 404 “381870044307”). Computer system 100 later receives a data transmission that fails to include the data. Thus, computer system 100 determines that the particular packaged item is missing from dispenser 104. Based on mapping 400, computer system 100 may determine a vendor 402 of the particular packaged item. Accordingly, computer system 100 may pass “381870044307” to “https://shop.riteaid.com/checkout/cart”.

4.0 Example Network Topology for Dispenser Supply Management

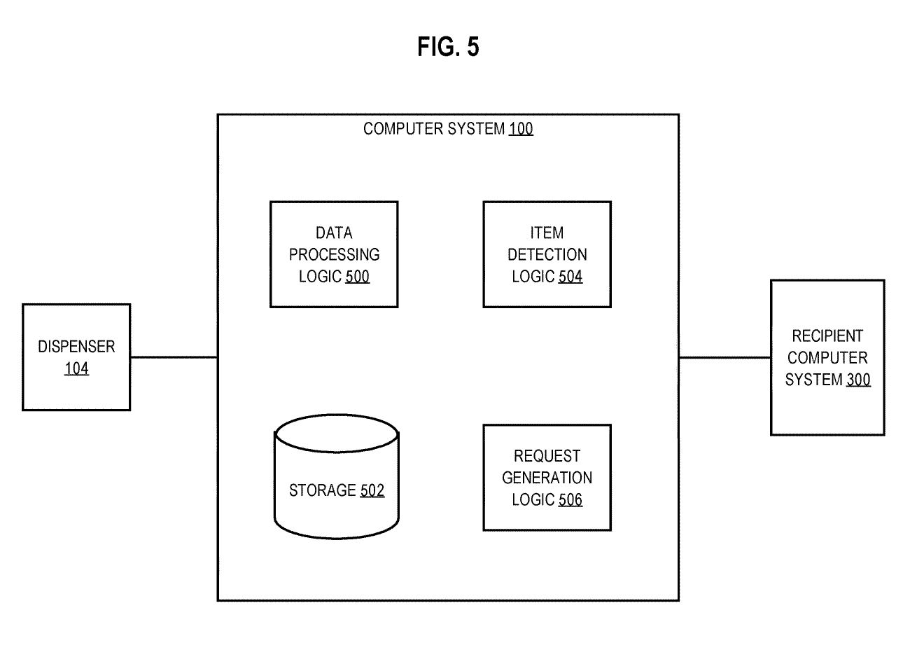

FIG. 5 depicts an example computer architecture comprising the supply management system of FIG. 1 and recipient computer system 300 of FIG. 3. Referring to FIG. 5, the supply management system includes dispenser 104 and computer system 100, which is communicatively coupled to recipient computer system 300. Computer system 100 includes data processing logic 500, storage 502, item detection logic 504, and request generation logic 506.

4.1 Dispenser

Dispenser 104 is configured to hold a plurality of sets (for example, sets 116A-N) of different dispensable items. For example, dispenser 104 may hold a set of bandages, a set of pain relievers, and a set of antiseptic towellettes. Dispenser 104 includes means for controllably dispensing an individual item from one of the sets in response to selection of the individual item. For example, dispenser 104 may include a transparent front panel that has slots through which continuous strips of rolled items are dispensed. In this example, selecting an individual item may involve selecting a particular slot that corresponds to the individual item. Dispenser 104 may also include vertical dividers to separate the sets.

Dispenser 104 also holds a plurality of transmitters. For example, each transmitter of the plurality of transmitters may correspond to a different set of the plurality of sets. Computer system 100 periodically receives one or more data transmissions from each transmitter. The one or more data transmissions may involve a wireless communication protocol, such as NFC. For example, each transmitter may be an RFID tag 112 that computer system 100 periodically interrogates using a NFC transceiver 102.

4.2 Computer System

Computer system 100 may be part of or separate from dispenser 104. Computer system 100 includes one or more processors and one or more computer-readable media coupled to the one or more processors. The one or more computer-readable media store instructions that are executed by the one or more processors. In some example embodiments, computer system 100 also includes a transceiver, a camera, and/or a barcode scanner.

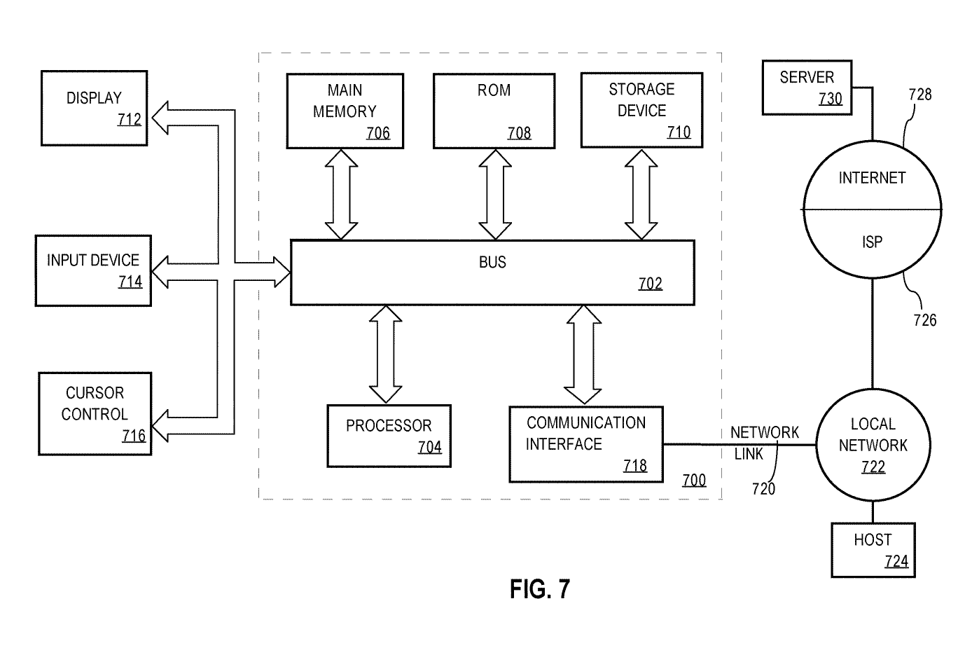

In the example of FIG. 5, the instructions are depicted as logical units, each of which may be implemented using any of the techniques further described herein in connection with FIG. 7. For example, computer system 100 may include a general-purpose computer configured with one or more stored programs which when executed cause performing the functions described herein for one or more logical units; a special-purpose computer with digital logic that is configured to execute the functions; or digital logic that is used in other computing devices. Each of the logical units may be communicatively coupled with each other and/or to storage 502.

4.2.1 Data Processing Logic

Data processing logic 500 processes data transmissions 114 that are received from the plurality of transmitters. More specifically, data processing logic 500 periodically receives one or more data transmissions from each transmitter of the plurality of transmitters. The one or more data transmissions may include information such as an item identifier (for example, any of packaged item identifiers 200A-N), a dispenser identifier 204, and/or a location identifier. Data processing logic 500 may parse and/or store the information in storage 502. In some example embodiments, data processing logic 500 may send a copy of the information to item detection logic 504.

4.2.2 Storage

Storage 502 stores information related to items contained in dispenser 104. Storage 502 may include a database, a configuration file, and/or any other system and/or data structure that stores data. For example, storage 502 may include a circular buffer. Storage 502 may include volatile and/or non-volatile memory. Storage 502 may store any information included in a data transmission. Additionally or alternatively, storage 502 may be pre-configured with information related to items contained in dispenser 104.

In some example embodiments, storage 502 may store one or more mappings (for example, mapping 400) between information included in a data transmission and information used to generate a resupply request 302. For example, computer system 100 may use an item-identifier-to-item-name mapping to correlate “381370044307” to “BANDAID BANDAGES”.

In some example embodiments, storage 502 may store historical data related to data transmissions 114. For example, storage 502 may include a log of each data transmission. The log may include information included in each data transmission and/or a timestamp for each data transmission.

In some example embodiments, storage 502 may store historical data related to resupply requests. For example, storage 502 may include a log of each resupply request. In particular, the log may include shipping options specified in each resupply request.

4.2.3 Item Detection Logic

Item detection logic 504 compares information included in a most recent set of data transmissions to information included in a previous set of data transmissions. For example, the previous set may be a set that immediately preceded the most recent set. Item detection logic 504 may retrieve the information included in the previous set from storage 502. Item detection logic 504 may also retrieve the information included in the most recent set from storage 502. Alternatively, item detection logic 504 may receive a copy of the information included in the most recent set from data processing logic 500.

If all item identifiers in the previous set match are included in the most recent set, item detection logic 504 determines that resupplying dispenser 104 is unnecessary. Conversely, if any of the item identifiers in the previous set are missing from the most recent set, item detection logic 504 determines that resupplying dispenser 104 is necessary. Furthermore, item detection logic 504 communicates one or more missing identifiers to request generation logic 506.

4.2.4 Request Generation Logic

Request generation logic 506 automatically generates a request to resupply dispenser 104. Request generation logic 506 determines which items are missing based on the one or more missing identifiers received from item detection logic 504. In some example embodiments, request generation logic 506 retrieves, from storage 502, information related to the one or more missing identifiers. For example, the information may include vendor information, item descriptions, location information, and/or any other information necessary to generate a resupply request 302. When request generation logic 506 generates the resupply request 302, computer system 100 automatically generates a digital electronic message that includes the resupply request 302 and transmits the digital electronic message toward recipient computer system 300 via a computer network.

4.3 Recipient Computer System

Recipient computer system 300 may be one or more physical computers, virtual computers, and/or computing devices. For example, recipient computer system 300 may be one or more server computers; cloud-based computers; cloud-based cluster of computers; virtual machine instances or virtual machine computing elements such as virtual processors, storage and memory; data centers; storage devices; desktop computers; laptop computers; mobile devices; and/or any other special-purpose computing devices. Recipient computer system 300 is associated with a vendor, a manufacturer, an inventory manager, and/or any other entity who is capable of supplying dispenser 104 with dispensable items.

5.0 Process Overview

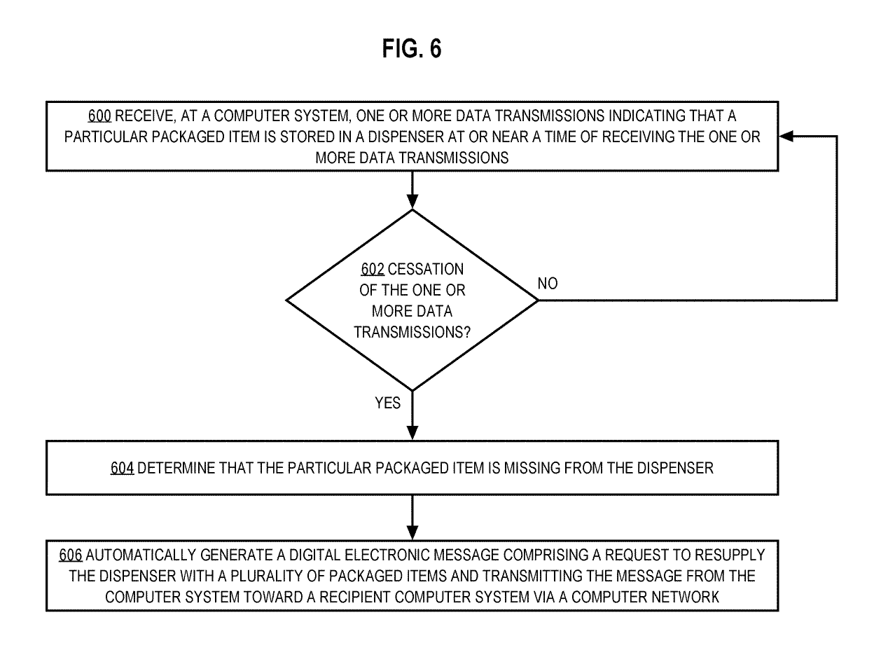

FIG. 6 is a flow diagram that depicts an approach for automated inventory control. The approach is implemented in computer system 100 of a supply management system (for example, the supply management system of FIG. 1 and/or FIG. 3).

5.1 Receiving an Indication that a Packaged Item is Stored in a Dispenser

At block 600, computer system 100 periodically receives one or more data transmissions. The one or more data transmissions indicate that a particular packaged item is stored in dispenser 104 at or near a time that computer system 100 receives the one or more data transmissions. For example, the one or more data transmissions may be one or more radio signals that encode an item identifier. The one or more radio signals are transmitted from a transmitter 110 that is affixed to the particular packaged item. As long as the particular packaged item is stored in dispenser 104, computer system 100 will continue to receive the one or more data transmissions from the transmitter 110. For example, computer system 100 may be located within a particular range from dispenser 104, because computer system 100 can only communicate with transmitters within the particular range.

5.2 Determining that the Packaged Item is Missing from the Dispenser

At block 602, computer system 100 determines whether it detects a cessation of the one or more data transmissions. If so, block 602 proceeds to block 604. Otherwise block 602 proceeds to block 600.

The cessation indicates that the particular packaged item and the transmitter 110 affixed to it have been dispensed. For example, the transmitter 110 and packaging material for the particular packaged item may have been discarded into a waste receptacle that is located outside the particular range. Typically, computer system 100 concurrently receives data transmissions 114 from multiple transmitters as a set of data transmissions. Thus, computer system 100 may infer the cessation based on determining that one or more item identifiers are missing from a particular set of data transmissions. In other words, detecting a cessation may involve receiving a set of data transmissions that includes one or more item identifiers and later receiving another set of data transmissions that fails to include the one or more item identifiers.

At block 604, computer system 100 determines that the particular packaged item is missing from dispenser 104. For example, computer system 100 may determine that the particular packaged item is missing based on correlating a missing item identifier to the particular packaged item.

5.3 Generating a Resupply Request

At block 606, computer system 100 automatically generates a digital electronic message that includes a request to resupply dispenser 104 with a plurality of packaged items. Computer system 100 may automatically generate the request based on information included in a data transmission and/or information retrieved from one or more stored mappings. The plurality of packaged items may be of a similar or same type as the particular packaged item. Furthermore, computer system 100 transmits the digital electronic message toward recipient computer system 300 via a computer network.

6.0 Implementation Mechanisms—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 7 is a block diagram that illustrates a computer system 700 upon which an embodiment may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (for example, x) and a second axis (for example, y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

7.0 Extensions and Alternatives

In the foregoing specification, the example embodiment(s) have been described with reference to numerous specific details. However, the details may vary from implementation to implementation according to the requirements of the particular implementation at hand. The example embodiment(s) are, accordingly, to be regarded in an illustrative rather than a restrictive sense.

What is claimed is:

1. A supply management system comprising:
a dispenser configured to hold a plurality of sets of different dispensable items;
means in the dispenser for controllably dispensing an individual item from one of the sets in response to selection of the individual item;
a computer system comprising one or more processors and one or more computer-readable media coupled to the one or more processors and storing instructions which, when executed by the one or more processors, cause the one or more processors to perform:
periodically receiving one or more data transmissions indicating that a particular packaged item is stored in the dispenser at or near a time of receiving the one or more data transmissions;
determining that the particular packaged item is missing from the sets of different dispensable items in the dispenser, based on a cessation of the one or more data transmissions;
in response to determining that the particular packaged item is missing from the dispenser, automatically generating a digital electronic message comprising a request to resupply the dispenser with a plurality of packaged items and transmitting the message from the computer system toward a recipient computer system via a computer network.

2. The supply management system of claim 1, further comprising receiving the one or more data transmissions from a transmitter affixed to the particular packaged item.

3. The supply management system of claim 1, further comprising receiving the one or more data transmissions from a radio-frequency identification (RFID) tag.

4. The supply management system of claim 1, further comprising receiving the one or more data transmissions using near field communication (NFC).

5. The supply management system of claim 1, wherein the one or more data transmissions include an identification of the particular packaged item.

6. The supply management system of claim 1, wherein the one or more data transmissions include an identification of the dispenser.

7. The supply management system of claim 1, wherein determining that the particular packaged item is missing from the dispenser based on a cessation of the one or more data transmissions further comprises receiving a set of data transmissions that includes data corresponding to the particular packaged item and later receiving a set of data transmissions that fails to include data corresponding to the particular packaged item.

8. The supply management system of claim 1, further comprising determining, based on the cessation of the one or more data transmissions, that the particular packaged item is missing but that one or more other packaged items of a same type are in the dispenser.

9. The supply management system of claim 1, further comprising automatically generating the digital electronic message by determining a vendor of the particular packaged item based on a stored mapping of vendor information to item information that is in the one or more data transmissions.

10. The supply management system of claim 1, further comprising automatically generating the digital electronic message by automatically generating the request using information included in the one or more data transmissions.

11. A supply management method comprising:
periodically receiving one or more data transmissions indicating that a particular packaged item is stored in a dispenser at or near a time of receiving the one or more data transmissions, the dispenser being configured to hold a plurality of sets of different dispensable items and comprising means in the dispenser for controllably dispensing an individual item from one of the sets in response to selection of the individual item;
determining that the particular packaged item is missing from the sets of different dispensable items in the dispenser, based on a cessation of the one or more data transmissions;
in response to determining that the particular packaged item is missing from the dispenser, automatically generating a digital electronic message comprising a request to resupply the dispenser with a plurality of packaged items and transmitting the message from the computer system toward a recipient computer system via a computer network,
wherein the method is performed by one or more computing devices.

12. The supply management method of claim 11, further comprising receiving the one or more data transmissions from a transmitter affixed to the particular packaged item.

13. The supply management method of claim 11, further comprising receiving the one or more data transmissions from a radio-frequency identification (RFID) tag.

14. The supply management method of claim 11, further comprising receiving the one or more data transmissions using near field communication (NFC).

15. The supply management method of claim 11, wherein the one or more data transmissions include an identification of the particular packaged item.

16. The supply management method of claim 11, wherein the one or more data transmissions include an identification of the dispenser.

17. The supply management method of claim 11, wherein determining that the particular packaged item is missing from the dispenser based on a cessation of the one or more data transmissions further comprises receiving a set of data transmissions that includes data corresponding to the particular packaged item and later receiving a set of data transmissions that fails to include data corresponding to the particular packaged item.

18. The supply management method of claim 11, further comprising determining, based on the cessation of the one or more data transmissions, that the particular packaged item is missing but that one or more other packaged items of a same type are in the dispenser.

19. The supply management method of claim 11, further comprising automatically generating the digital electronic message by determining a vendor of the particular packaged item based on a stored mapping of vendor information to item information that is in the one or more data transmissions.

20. The supply management method of claim 11, further comprising automatically generating the digital electronic message by automatically generating the request using information included in the one or more data transmissions.
